(19) United States
(12) Patent Application Publication
(10) Pub. No.: US 2019/0265964 A1
(43) Pub. Date: Aug. 29, 2019

(54) ELECTRONIC APPARATUS, UPDATING METHOD, AND RECORDING MEDIUM

(71) Applicant: Kazuma KOIKE, Kanagawa (JP)

(72) Inventor: Kazuma KOIKE, Kanagawa (JP)

(73) Assignee: Ricoh Company, Ltd., Tokyo (JP)

(21) Appl. No.: 16/278,854

(22) Filed: Feb. 19, 2019

(30) Foreign Application Priority Data
Feb. 28, 2018 (JP) 2018-035005

(51) Int. Cl. G06F 8/65; G06F 9/50

(52) U.S. Cl. CPC G06F 8/65; G06F 9/4401; G06F 9/5077

(57) ABSTRACT

An electronic apparatus includes one or a plurality of devices and processing circuitry. The one or a plurality of devices stores a plurality of multiplexed systems. The processing circuitry refers to specification information specifying a system to be started; set, as a system to be updated, a second system different from a first system specified as the system to be started; read a control program corresponding to the first system specified as the system to be started, to execute start processing on the first system; set update progress information indicating a progress state of update processing according to system update information acquired from an outside; and change the system to be started, which is specified in the specification information, from the first system to the second system after completion of update processing of a control program corresponding to the second system set as the system to be updated.

### CROSS-REFERENCE TO RELATED APPLICATION

This patent application is based on and claims priority pursuant to 35 U.S.C. § 119(a) to Japanese Patent Application No. 2018-035005, filed on Feb. 28, 2018, in the Japan Patent Office, the entire disclosure of which is hereby incorporated by reference herein.

### BACKGROUND

### Technical Field

Aspects of the present disclosure relate to an electronic apparatus multiplexed by a plurality of systems, a method for updating a plurality of systems, and a recording medium.

### Related Art

To control each hardware mounted on an electronic apparatus such as a personal computer (PC) or a printer, a program called firmware is used. The firmware is updated when defects, faults, vulnerabilities, or the like are found or when functions are added, and an update file is provided for updating the firmware.

The update of the firmware may fail due to reasons such as inability to read the update file. There is known a technology of multiplexing firmware in order to normally start the electronic apparatus and resume the update even if the update fails.

### SUMMARY

In an aspect of the present disclosure, there is provided an electronic apparatus that includes one or a plurality of devices and processing circuitry. The one or a plurality of devices stores a plurality of multiplexed systems. The processing circuitry refers to specification information specifying a system to be started; set, as a system to be updated, a second system different from a first system specified as the system to be started, the plurality of multiplexed systems including the first system and the second system; read a control program corresponding to the first system specified as the system to be started, to execute start processing on the first system; set update progress information indicating a progress state of update processing according to system update information acquired from an outside of the electronic apparatus; and change the system to be started, which is specified in the specification information, from the first system to the second system after completion of update processing of a control program corresponding to the second system set as the system to be updated.

In another aspect of the present disclosure, there is provided a method for updating a plurality of systems. The method includes: referring to specification information specifying a system to be started; setting, as a system to be updated, a second system different from a first system specified as the system to be started; reading a control program corresponding to the first system to execute start processing on the first system; setting update progress information indicating a progress state of update processing according to system update information acquired from an outside; and changing the system to be started, which is specified in the specification information, from the first system to the second system according to the system update information after completing update processing of a control program corresponding to the second system set as the system to be updated.

In still another aspect of the present disclosure, there is provided a non-transitory recording medium that stores a plurality of instructions which, when executed by one or more processors, cause the processors to perform: setting, as a system to be updated, second system different from a first system by reference to specification information specifying a system to be started; reading a control program corresponding to the first system, and executing start processing; setting update progress information indicating a progress state of update processing according to system update information acquired from an outside; and changing the system to be specified by the specification information to the second system according to the system update information after completing the update processing of a control program corresponding to the second system set as the system to be updated.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a hardware configuration of an image forming apparatus;

FIG. 2 is a diagram illustrating an example of hardware and software configurations of the image forming apparatus;

FIG. 3 is a block diagram illustrating a main functional configuration regarding start processing of the image forming apparatus;

FIG. 4 is a block diagram illustrating a first functional configuration regarding system update of the image forming apparatus;

FIG. 5 is a diagram illustrating an example of a data structure of an update file;

FIG. 6 is a flowchart illustrating a first example of the start processing of the image forming apparatus;

FIG. 7 is a flowchart illustrating a first example of processing in a case where a system update notification of the image forming apparatus comes;

FIG. 8 is a flowchart illustrating a first example of processing in a case where update interruption information is stored in a non-volatile random access memory (NVRAM);

FIG. 9 is a diagram for describing transition of storage information to be stored in the NVRAM;

FIG. 10 is a flowchart illustrating a first example of processing in a case where update interruption occurs in a section 1 in transition of the storage information;

FIG. 11 is a flowchart illustrating a first example of processing in a case where update interruption occurs in a section 2 in transition of the storage information;

FIG. 12 is a diagram for describing a file system;

FIG. 13 is a block diagram illustrating a second functional configuration regarding system update of the image forming apparatus;

FIGS. 14A and 14B (FIG. 14) are a flowchart illustrating a second example of processing in a case where a system update notification of the image forming apparatus comes;

FIGS. 15A and 15B (FIG. 15) are a flowchart illustrating a second example of processing in a case where update interruption information is stored in the NVRAM;

FIG. 16 is a flowchart illustrating a second example of processing in a case where update interruption occurs in a section 1 in transition of the storage information; and

FIG. 17 is a flowchart illustrating a second example of processing in a case where update interruption occurs in a section 2 in transition of the storage information.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, an electronic apparatus of the present embodiment will be described as an image forming apparatus, but the electronic apparatus is not limited to the image forming apparatus. Examples of the image forming apparatus include, in addition to a copying machine, a facsimile device, a scanner device, and a printer, a multifunction peripheral having multifunction peripheral functions to handle images such as copying, facsimile, scanner, and printing. Hereinafter, the image forming apparatus will be described as a multifunction peripheral.

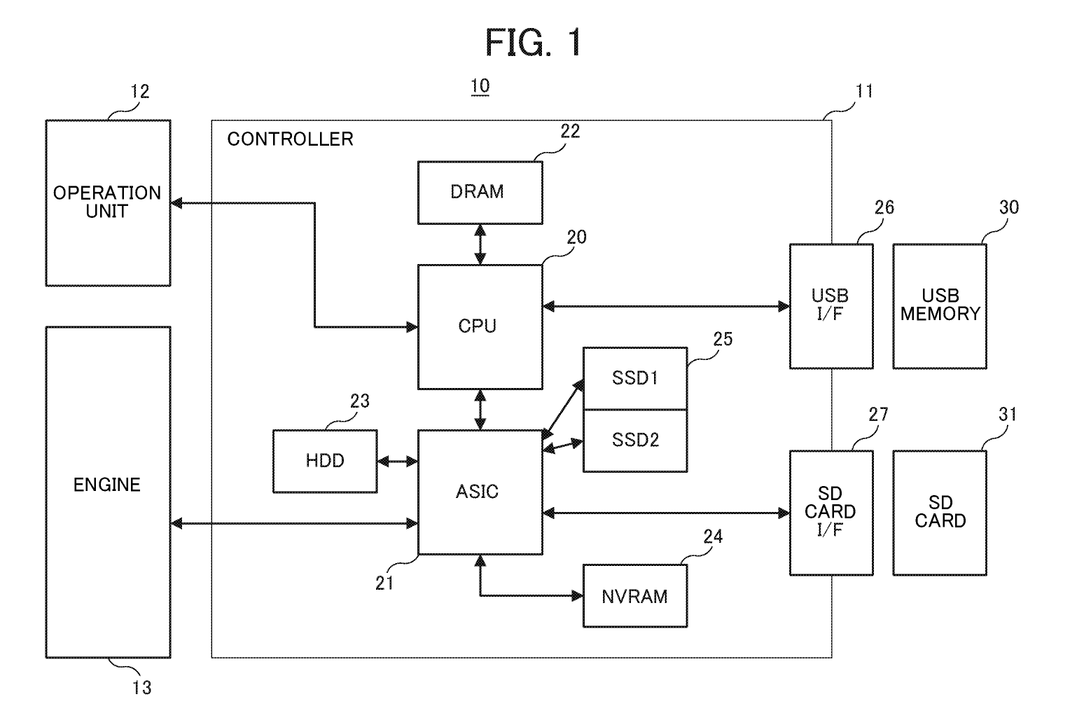

FIG. 1 is a diagram illustrating an example of a hardware configuration of an image forming apparatus 10. The image forming apparatus 10 includes a controller 11, an operation unit 12, and an engine 13. The controller 11 includes a central processing unit (CPU) 20, an application specific integration circuit (ASIC) 21, a dynamic random access memory (DRAM) 22, a hard disk drive (HDD) 23, a non-volatile random access memory (NVRAM) 24 as a non-volatile memory, and a solid state disk (SSD) 25. Further, the controller 11 includes a universal serial bus (USB) interface (I/F) 26 connecting a USB memory 30 and controlling read/write to/from the USB memory 30, and a secure digital (SD) card interface (I/F) 27 connecting an SD card 31 and controlling read/write to/from the SD card 31.

The CPU 20 controls the entire image forming apparatus 10, and executes predetermined processing, using the DRAM 22 as a working storage area. The CPU 20 is connected to the HDD 23 via the ASIC 21, reads various programs from the HDD 23 to the DRAM 22, and executes the programs. The CPU 20 is connected to the USB I/F 26 and receives a print job and the like from the USB memory 30. Therefore, the DRAM 22 is also used as a drawing memory and the like for processing the print job. Further, the CPU 20 is connected to the operation unit 12, and creates and provides a screen to be displayed by the operation unit 12 on the basis of various instruction inputs received by the operation unit 12.

The ASIC 21 reads image data stored in the HDD 23 and executes various types of image processing. The ASIC 21 is connected to the SSD 25. The SSD 25 includes a storage area that is logically divided into two logical partitions (partitions), and a control program corresponding to a system is stored in each of the partitions to duplicate the system.

Here, the system is a set including firmware for controlling the hardware and higher-level applications (hereinafter abbreviated as applications). The duplication of the system means a configuration in which two sets of control programs corresponding to the system are prepared and the respective control programs are stored in the respective partitions of the SSD 25, and a system to be started is made selectable. Each system may have the same configuration, or may have the same minimum configuration and have a different configuration.

In the example illustrated in FIG. 1, partitions called “SSD 1” and “SSD 2” are formed. In this example, the SSD 25 is separately provided from the HDD 23. However, the HDD 23 alone may be provided and logically divided to form partitions, or the SSD 25 alone may be provided without the HDD 23 and image data and the like used by the ASIC 21 may be stored in the SSD 25.

The NVRAM 24 stores various types of system information and various types of setting information of the image forming apparatus 10. In the present embodiment, the NVRAM 24 stores update interruption information to be described below.

The operation unit 12 receives various instruction inputs from the user and provides a user interface for displaying a screen. The engine 13 is connected to the ASIC 21, receives commands issued by various programs executed by the CPU 20, and executes image forming processing, image reading processing, and the like.

The SD card 31 is an external recording medium and stores an update file as update information used for updating the system. The CPU 20 executes a program to read the update file from the SD card 31, rewrites the control program stored in each partition of the SSD 25, and updates the system.

In FIG. 1, the control program is stored for each partition of the SSD 25 to multiplex the system. However, another SSD may be provided in addition to the SSD 25 and the control program may be stored for each apparatus (device) to multiplex the system. Note that the multiplexing of the system is not limited to duplication, and may be triplication or more.

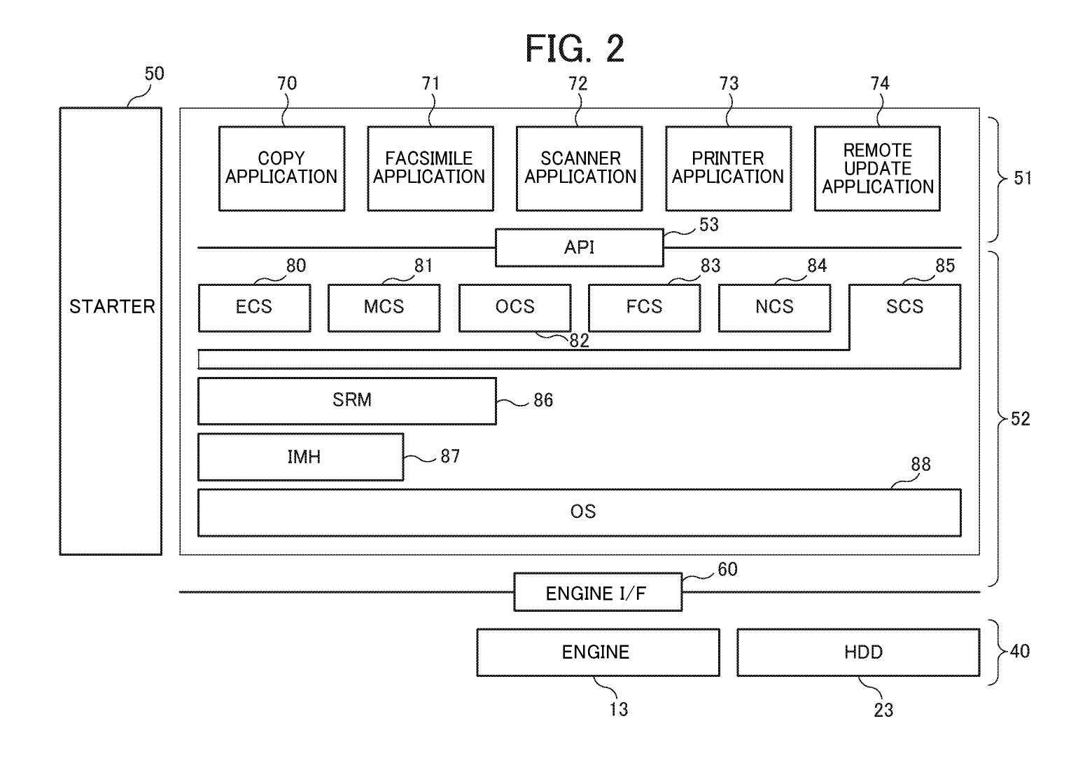

FIG. 2 is a diagram illustrating an example of hardware and software configurations of the image forming apparatus 10. The hardware includes devices such as the HDD 23 and the engine 13, and these devices are referred to as hardware resources 40. The software includes a starter 50, an application layer 51, and a platform layer 52.

An engine I/F 60 for connecting the engine 13 and the platform layer 52 is provided between the engine 13 and the platform layer 52.

The application layer 51 includes various applications for providing various functions. The application layer 51 includes, as applications, a copy application 70, a facsimile application 71, a scanner application 72, a printer application 73, and a remote update application 74.

The copy application 70 executes processing of reading, printing, and outputting a document. The facsimile application 71 executes processing of reading and transmitting a document by facsimile, and processing of receiving, printing, and outputting a facsimile. The scanner application 72 executes processing of reading a document, and the printer application 73 executes processing of printing and outputting read document and image data. The remote update application 74 downloads the latest system via the Internet when determining that system update is required, and executes update processing of the system.

The application layer 51 is connected to the platform layer 52 by an application programming interface (API) 53. The API 53 has a predefined function, receives a processing request from the application layer 51, and causes the platform layer 52 to process the processing request.

The platform layer 52 includes various control services such as an engine control service (ECS) 80, a memory control service (MCS) 81, an operation control service (OCS) 82, a facsimile control service (FCS) 83, a network control service (NCS) 84, and a system control service (SCS) 85. The control service interprets the processing request from the application layer 51 and generates an acquisition request for the hardware resources 40.

The ECS 80 controls the hardware resources 40 such as the engine 13 and the HDD 23, and controls reading of an image, image forming operation, and the like. The MCS 81 performs memory control such as acquisition and release of an image memory, compression and decompression of image data, and the like. The OCS 82 controls the operation unit 12 that serves as an interface between the user and the image forming apparatus 10. The FCS 83 is connected to a general switched telephone network (GSTN) interface, and controls facsimile transmission/reception using a GSTN network, facsimile reading, and the like.

The NCS 84 controls a network interface card (NIC) to connect the image forming apparatus 10 to the Internet or Ethernet (registered trademark), and provides commonly usable services to the applications requiring network input/output (I/O). The NCS 84 distributes data received by each protocol from the network side to each application, and mediates when data from each application is transmitted to the network side.

The SCS 85 performs management of each application, control of a user interface such as system screen display and light-emitting diode (LED) display, management of the hardware resources 40, control of an interruption application, and the like.

The platform layer 52 also includes a system resource manager (SRM) 86, an image memory handler (IMH) 87, and an operation system (OS) 88. The SRM 86 arbitrates the engine 13 through the OS 88. The IMH 87 controls transfer of image data between the controller 11 and the engine 13 through the OS 88. The OS 88 provides a standard interface to each application and service and efficiently manages the hardware resources 40. As the OS 88, UNIX (registered trademark), WINDOWS (registered trademark), or the like can be used.

The starter 50 is started when power of the image forming apparatus 10 is turned on, reads a control program corresponding to the process group of the application layer 51 and the platform layer 52, expands the control program in the memory, and starts a process. By the start of the process, the system is started and each functional is implemented.

The image forming apparatus 10 is made redundant by one of the two systems (hereinafter referred to as a primary system) and the other system (hereinafter referred to as a secondary system). Therefore, even if one of the systems suffers failure due to interruption of the update processing, the other system can be started.

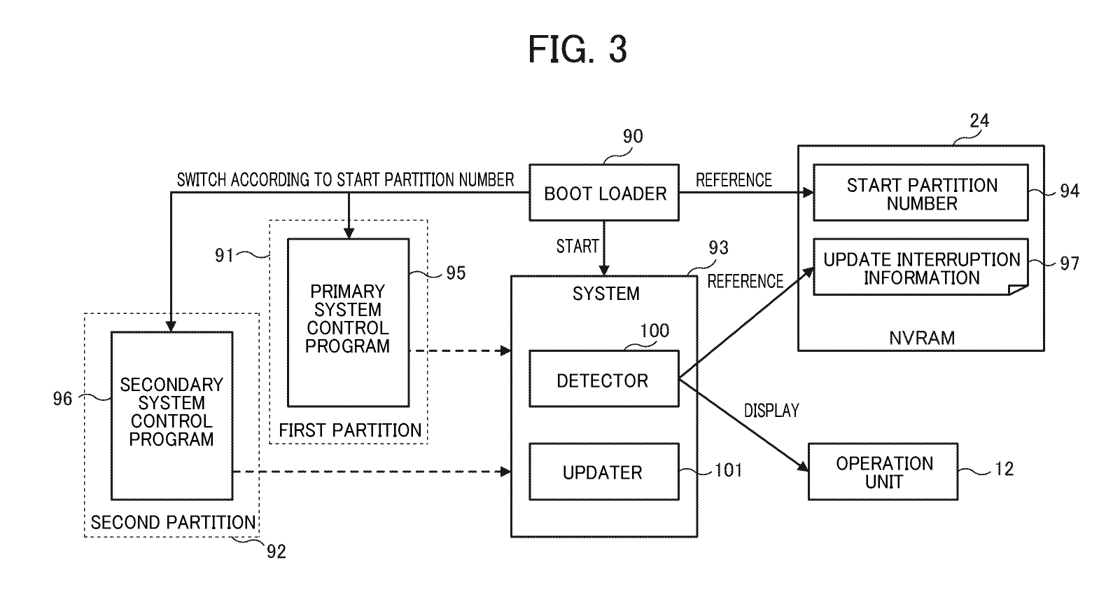

Start processing of the image forming apparatus 10 will be described with reference to FIG. 3. FIG. 3 is a block diagram illustrating a main functional configuration regarding the start processing of the image forming apparatus 10. FIG. 3 illustrates a boot loader 90 functioning as a booster, the NVRAM 24, a first partition 91 and a second partition 92 given by the storage areas of the SSD 25, the operation unit 12, and a system 93.

The NVRAM 24 functions as a storage, is referred to by the boot loader 90, and stores, as specification information specifying a system to be started, a start partition number 94 for identifying a partition where the system to be started exists. The first partition 91 and the second partition 92 store control programs 95 and 96 respectively corresponding to the two redundant systems. Therefore, the boot loader 90 can switch the control program to be read in accordance with the start partition number 94, and start the system.

When the user turns on the power of the image forming apparatus 10, the boot loader 90 is started and determines the partition to be started by reference to the start partition number 94 stored in the NVRAM 24. Then, the control program is read from the partition determined by the boot loader 90, and the start processing of the system 93 is executed.

The NVRAM 24 stores update interruption information 97 indicating a state (status) of update processing in addition to the start partition number 94. The update interruption information 97 includes a module identification (ID) for identifying a module to be updated and an index indicating an execution order of the update processing. The module is firmware, applications, and the like constituting the system.

The index is information indicating a progress state of the update processing. The index is set to “1/2” in a case where the current update processing processes the primary system and is set to “2/2” in a case where the current update processing processes the secondary system, in a case of executing the update processing in order of the primary system and the secondary system, for example. A value preceding a symbol “I” of the index, that is, a first numerical value of the index indicates the order of the system update processing, and a value behind the symbol “/”, that is, a numerical value after the index indicates the total number of processing.

The system 93 started by the boot loader 90 includes a detector 100 and an updater 101.

The detector 100 refers to the storage information stored in the NVRAM 24 and confirms whether there is the update interruption information 97 in the referred storage information. That is, the detector 100 determines whether the module ID and the index are set. In a case where there is the update interruption information 97, the detector 100 detects that the system update has been interrupted. The update interruption information 97 is set by the start of the update processing, and the setting is erased upon completion of the update processing. Therefore, the fact that the update interruption information 97 is present means that the update processing has been interrupted due to power off or the like.

The updater 101 analyzes the update file acquired from the outside such as the SD card 31, determines whether update can be started, and starts the update of the system in a case where the update can be started. The updater 101 instructs the operation unit 12 functioning as a notifier to notify the user of an error in a case where the update cannot be started.

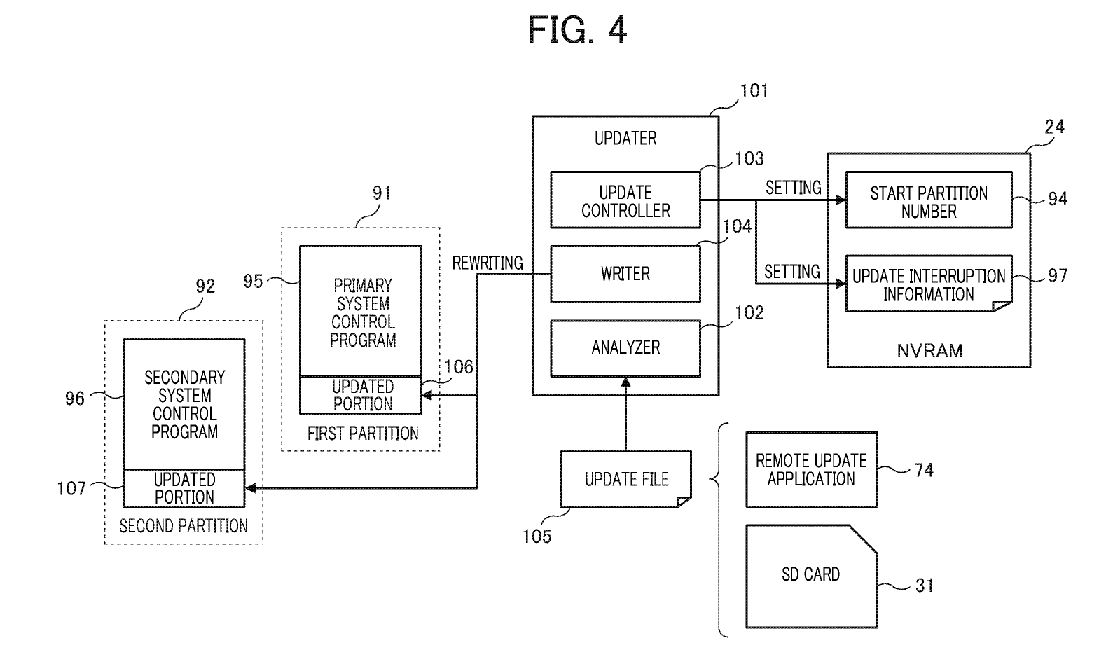

The system update of the image forming apparatus 10 will be described with reference to FIG. 4. FIG. 4 is a block diagram illustrating a main functional configuration regarding the system update of the image forming apparatus. The started system 93 includes the updater 101, and the updater 101 includes an analyzer 102, an update controller 103, and a writer 104. As illustrated in FIG. 3, the NVRAM 24 includes the start partition number 94 and the update interruption information 97. In FIG. 4, the first partition 91 includes a primary system control program 95, and the second partition 92 includes a secondary system control program 96.

An update file 105 of the system provided by the SD card 31 is read from the SD card 31 and expands in the memory. Note that the update file 105 may be downloaded via the Internet by the remote update application 74 and expanded in the memory. The memory is the DRAM 22.

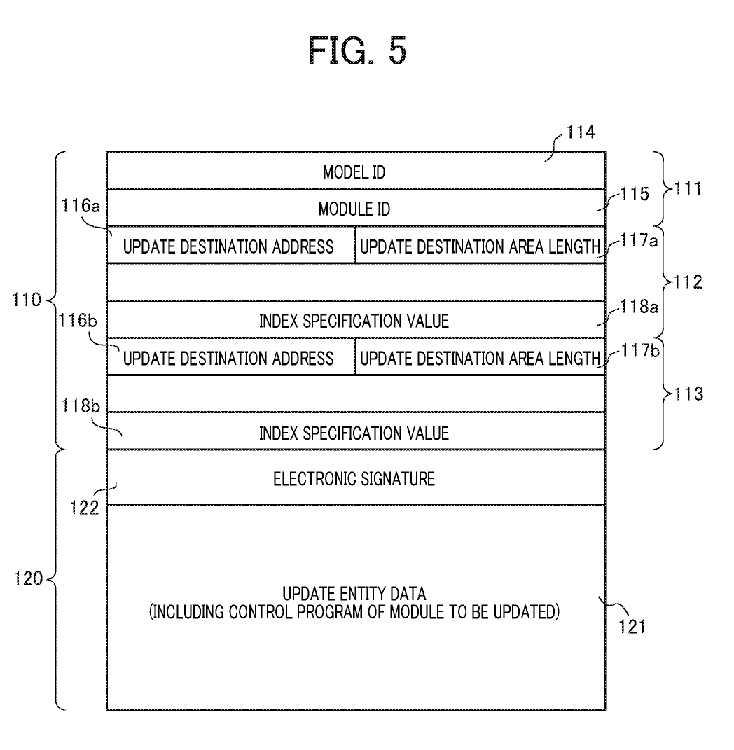

The analyzer 102 analyzes the update file 105 expanded in the memory and extracts required information from the update file 105. FIG. 5 illustrates a configuration example of the update file 105. The update file 105 includes a header section 110 placed in the head of data separately from a data body and a data section 120 in which the data body is recorded.

The header section 110 includes a common header 111 that defines matters common to the primary system and the secondary system, a primary system header 112 that defines matters specific to the primary system, and a secondary system header 113 that defines matters specific to the secondary system.

The common header 111 includes a model ID 114 for specifying a model of the image forming apparatus 10 and a module ID 115 to be updated. The primary system header 112 and the secondary system header 113 respectively include update destination addresses 116a and 116b indicating update destination storage areas, update destination area lengths 117a and 117b indicating the sizes of the update destination storage areas, and index specification values 118a and 118b. The index specification values 118a and 118b are values to be set in the index of the update interruption information 97.

The data section 120 includes update entity data 121 which includes the control program described by a binary execution code of a module to be updated and rewrites each update part of each partition, and an electronic signature 122 attached to guarantee validity of the update entity data 121.

The electronic signature 122 is obtained by calculating a hash value from the update entity data 121 using a function called hash function and encrypting the calculated hash value using a secret key. The electronic signature 122 is given by a creator of the update file 105. Therefore, a person who intends to perform update with the update file 105 applies the hash function to the update entity data 121 included in the update file 105 to calculate the hash value, decrypts the secret key using a public key corresponding to the secret key, and confirms whether the hash values match, thereby verifying the validity of the electronic signature 122. As the electronic signature 122, a Rivest-Shamir-Adleman (RSA) signature, a digital signature algorithm (DSA) signature, a Schnorr signature, an ElGamal signature, or the like can be adopted, for example.

Referring again to FIG. 4, the analyzer 102 extracts the information included in each header such as the model ID 114 included in the common header 111, and data to be updated, as the required information.

The update controller 103 sets the update interruption information 97 before the start of the update, and changes the start partition number 94 after completion of the update. Further, the update controller 103 starts the update processing of the control program corresponding to the system to be updated in response to acquisition of the update file 105 from the external SD card 31 or the like.

The writer 104 rewrites the control programs stored in the partitions on the basis of the extracted update destination addresses 116a and 116b, update destination area lengths 117a and 117b, and update entity data 121 in response to the start of the update processing by the update controller 103. In the example illustrated in FIG. 4, part of the control programs 95 and 96 is updated, and the part is illustrated as updated portions 106 and 107.

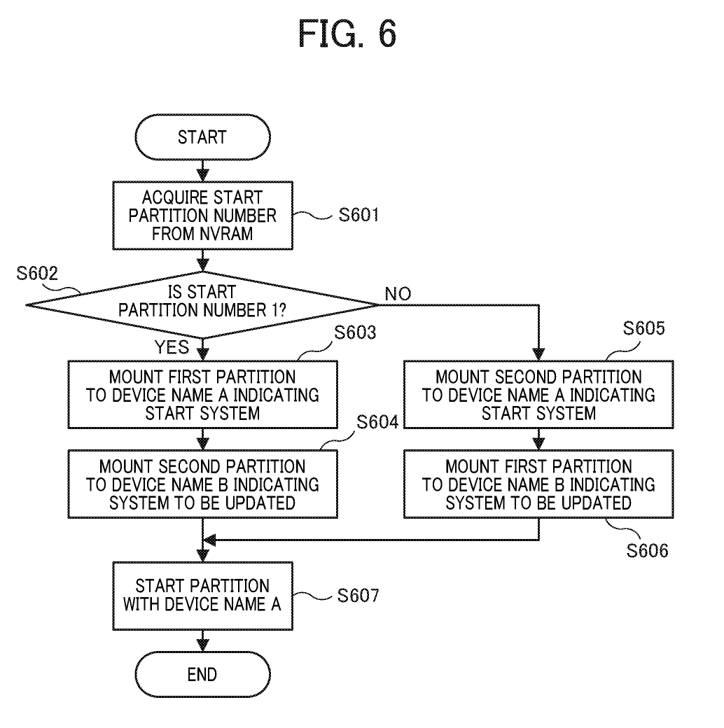

The start processing of the image forming apparatus 10 will be described in detail with reference to FIG. 6. The user presses a power button of the image forming apparatus 10 to turn on the power to start the start processing. In step 601, the boot loader 90 is started, and the boot loader 90 acquires the start partition number 94 from the NVRAM 24.

In step 602, the boot loader 90 confirms whether the acquired start partition number 94 is a number “1” indicating the first partition 91. In a case where the start partition number 94 is the number “1” indicating the first partition 91, the processing proceeds to step 603, and the boot loader 90 allocates the first partition 91 to a device name A that is device information to be referred to as a device where a start system exists to make the first partition 91 startable. That is, the boot loader 90 mounts the first partition 91 to the device name A. Then, in step 604, the boot loader 90 mounts the second partition 92 different from the first partition 91 to a device name B to be referred to as a device where a system to be updated exists to make the system startable.

Meanwhile, in step 602, in a case where the start partition number 94 is not the number indicating the first partition 91, the processing proceeds to step 605, and the boot loader 90 mounts the second partition 92 to the device name A indicating the start system. Then, in step 606, the boot loader 90 mounts the first partition 91 different from the second partition 92 to the device name B indicating the system to be updated.

In step 607, the boot loader 90 reads the control program existing in the partition mounted to the device name A indicating the start system, and starts the system 93. By the start of the system 93, the boot loader 90 terminates the start processing.

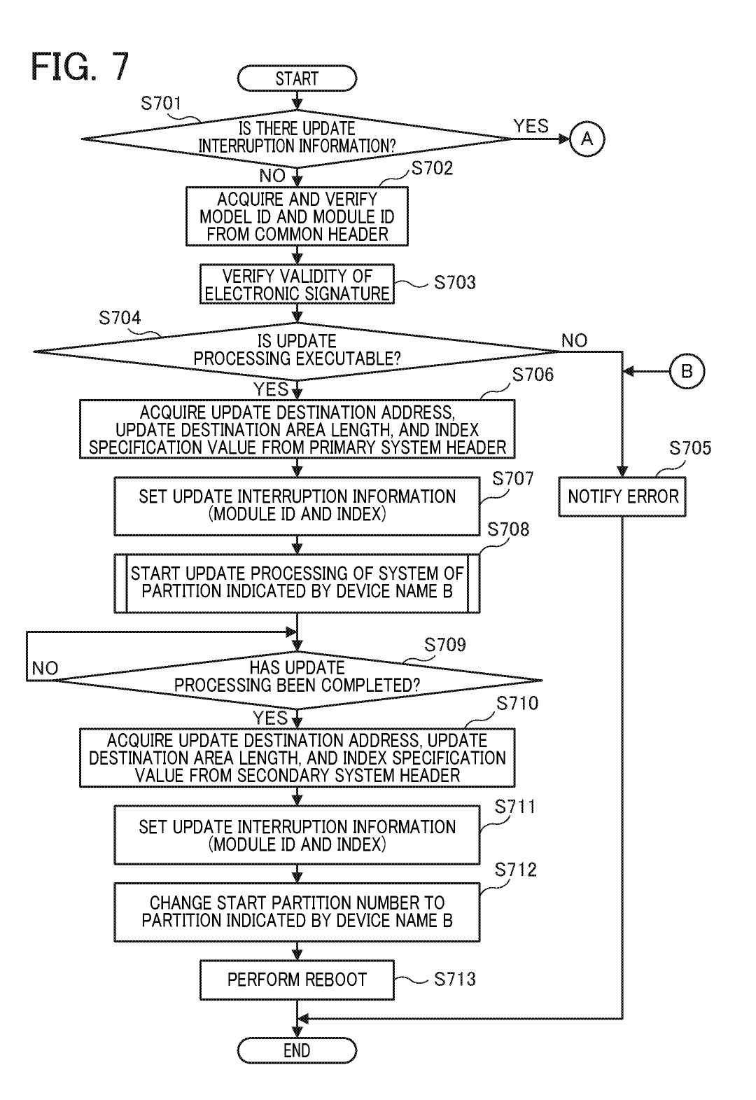

Next, processing when a system update notification comes after completion of the start processing will be described in detail with reference to FIG. 7. The processing is started by insertion of the SD card 31 into an SD card slot or downloading of the update file 105. In step 701, the detector 100 confirms whether the update interruption information 97 is stored in the NVRAM 24. In a case where the update interruption information 97 is stored as a result of the confirmation, the processing proceeds to the sign A. In a case where the update interruption information 97 is not stored, the processing is normal update processing and proceeds to step 702.

In step 702, the analyzer 102 included in the updater 101 acquires and verifies the model ID 114 and the module ID 115 from the common header 111 included in the update file 105. The verification is performed by confirming whether the acquired model ID 114 matches a model ID of the image forming apparatus 10 and confirming whether there is a module that matches the acquired module ID 115 in the modules mounted in the image forming apparatus 10.

In step 703, the analyzer 102 acquires the electronic signature 122 from the data section 120 included in the update file 105, and verifies the validity of the electronic signature 122. Since the method for verifying the validity of the electronic signature 122 has already been described, description of the method is omitted here.

In step 704, whether the update processing can be executed is determined on the basis of the verification result of the model ID 114 and the module ID 115 and the verification result of the validity of the electronic signature 122. In a case where the model ID 114 does not match the model ID in the verification result, a case where there is no module matching the module ID 115, or a case where the validity of the electronic signature 122 cannot be confirmed, the processing proceeds to step 705, as the update cannot be started, an error is notified, and the processing is terminated.

On the other hand, in step 704, in a case where the model ID 114 matches the model ID in the verification result, a case where there is a module matching the module ID 115, and a case where the validity of the electronic signature 122 can be confirmed, the processing proceeds to step 706, as the update can be started. In step 706, the update controller 103 acquires the update destination address 116a, the update destination area length 117a, and the index specification value 118a from the primary system header 112 of the update file 105.

In step 707, the update controller 103 sets the acquired module ID 115 and index specification value 118a as the update interruption information 97.

In step 708, the update controller 103 starts update of the system to be updated. The system to be updated is the system of the partition indicated by the device name B, and is the system started by the control program stored in the partition. The writer 104 rewrites the control program 95, using the update entity data 121, to update the system on the basis of the acquired update destination address 116a and update destination area length 117a.

In step 709, the update controller 103 confirms whether the rewriting of the control program 95 for starting the system has been completed, as the update of the system to be updated. When the rewriting has been completed, the processing proceeds to step 710, and the update controller 103 acquires the update destination address 116b, the update destination area length 117b, and the index specification value 118b from the secondary system header 113 of the update file 105.

In step 711, the update controller 103 rewrites and sets the module ID 115 and the index set in the update interruption information 97 stored in the NVRAM 24 to the acquired values. In step 712, the update controller 103 changes the start partition number 94 stored in the NVRAM 24 to the partition number of the partition indicated by the device name B. Then, the system is rebooted in step 713 and the processing is terminated.

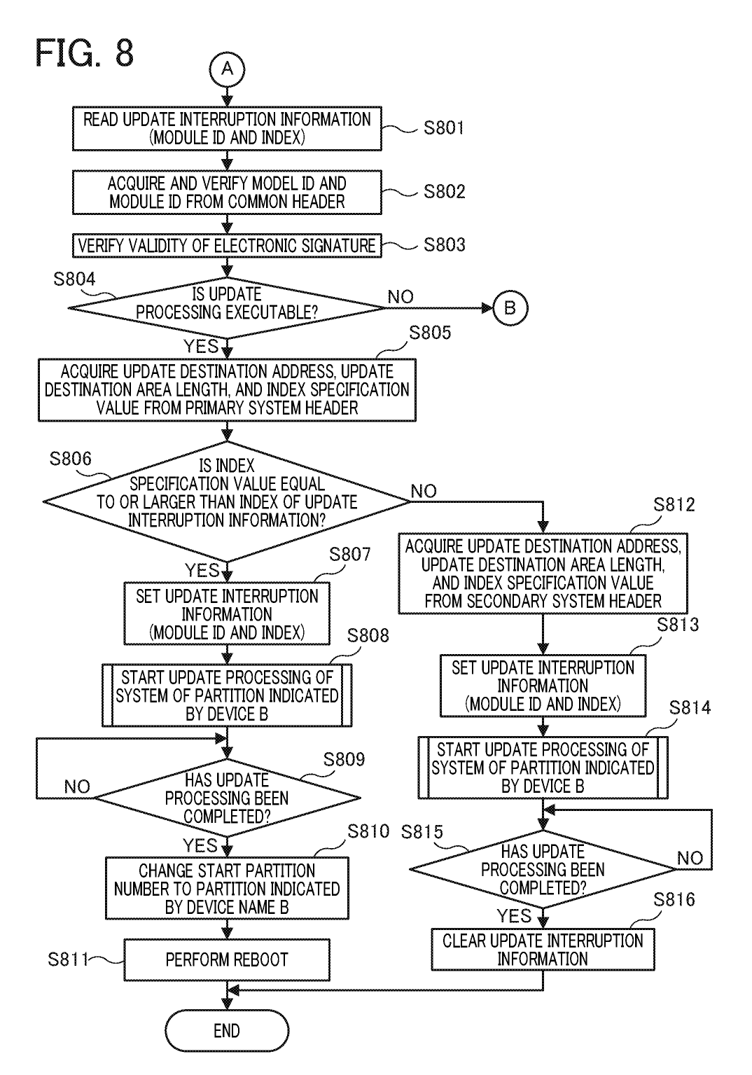

Processing in a case where the update interruption information 97 is stored in the NVRAM 24 in step 701 in FIG. 7 will be described with reference to FIG. 8. When the reboot is performed in step 713 in FIG. 7, the update interruption information 97 remains on the NVRAM 24. Therefore, the processing is started again and proceeds to the sign A in step 701, and the processing illustrated in FIG. 8 is executed. Starting from the sign A, in step 801, the update controller 103 reads and obtains the update interruption information 97 stored in the NVRAM 24.

In steps 802 and 803, processing similar to the processing in steps 702 and 703 illustrated in FIG. 7 is executed. In step 804, it is determined whether the update processing is executed on the basis of the verification result of the model ID 114 and the module ID 115 and the verification result of the validity of the electronic signature 122. In a case where the update cannot be started, the processing proceeds to the sign C and to step 705 in FIG. 7, an error is notified, and the processing is terminated.

In a case where the update can be started in step 804, the processing proceeds to step 805, and the update controller 103 acquires the update destination address 116a, the update destination area length 117a, and the index specification value 118a from the primary system header 112 of the update file 105.

In step 806, the update controller 103 compares the index included in the acquired update interruption information 97 with the acquired index specification value 118a, and confirms whether the index specification value 118a is equal to or larger than the value of the index. Since the index specification value 118a of the primary system header 112 is set to “1/2”, the index specification value 118a is equal to or larger than the value of the index in a case where the value of the index included in the update interruption information 97 is “1/2”.

Note that the case where the index specification value 118a is equal to or larger than the value of the index means that the progress state of the update is less than completion of the update of the primary system, and the update of the primary system has failed. The case where the index specification value 118a is less than the value of the index is a case where the value of the index is “2/2” whereas the index specification value 118a is “1/2”, and means that the update of the primary system has succeeded.

In the case of confirming that the index specification value 118a is equal to or larger than the value of the index in step 806, the processing proceeds to step 807 in order to update the primary system, and the update controller 103 rewrites the update interruption information 97 according to the acquired module ID 115 and index specification value 118a. In step 808, the update controller 103 starts the update processing of the system of the partition indicated by the device name B. In the case where the partition mounted to the device name B is the first partition 91, the update controller 103 starts the update processing of the system of the first partition 91. In step 809, the update controller 103 confirms whether the update processing has been completed.

When completion of the update processing has been confirmed in step 809, the processing proceeds to step 810, and the update controller 103 changes the start partition number 94 stored in the NVRAM 24 to the partition number of the partition indicated by the device name B. Then, the system is rebooted in step 811 and the processing is terminated. After the termination, the update interruption information 97 remains on the NVRAM 24. Therefore, the processing is started again and proceeds to the sign A in step 701, and the processing in FIG. 8 is executed.

In the case of confirming that the index specification value 118a is less than the value of the index in step 806, the update of the primary system has succeeded, and thus the processing proceeds to step 812 in order to update the secondary system. Since the processing from steps 812 to 816 is synchronous processing to the secondary side, the processing is performed in the background of normal start.

In step 812, the update controller 103 acquires the update destination address 116b, the update destination area length 117b, and the index specification value 118b from the secondary system header 113 of the update file 105.

In step 813, the update controller 103 rewrites the update interruption information 97 according to the acquired module ID 115 and index specification value 118b. In step 814, the update controller 103 starts update of the system to be updated. The system to be updated is the system of the partition indicated by the device name B. In the device name B at this time, the start partition number 94 has been changed from the second partition 92 to the first partition 91 in step 712 in FIG. 7, for example, and thus the second partition 92 is mounted. Therefore, the system to be updated is the system of the second partition 92.

In step 815, the update controller 103 confirms whether the update processing has been completed. When completion of the update processing has been confirmed in step 815, the processing proceeds to step 816, and the update controller 103 erases the update interruption information 97 stored in the NVRAM 24, and terminates the processing. As a result, the whole update is completed.

The active system during execution of the processing of steps 812 to 816 illustrated in FIG. 8 alone satisfies the functions as the image forming apparatus 10. This is because the active system is the primary system that has succeeded in update. The above update processing is simply synchronized to match versions of the system of both the partitions. Therefore, reboot of the system is not required.

The processing of steps 812 to 816 illustrated in FIG. 8 can be executed in the background of normal startup. Therefore, the user feels as if the system update is completed at about a double speed and use of the image forming apparatus 10 becomes possible, as compared with the conventional processing of rebooting the system and starting the partition indicated by the device name A, updating the system of the partition indicated by the device name B, and rebooting the system.

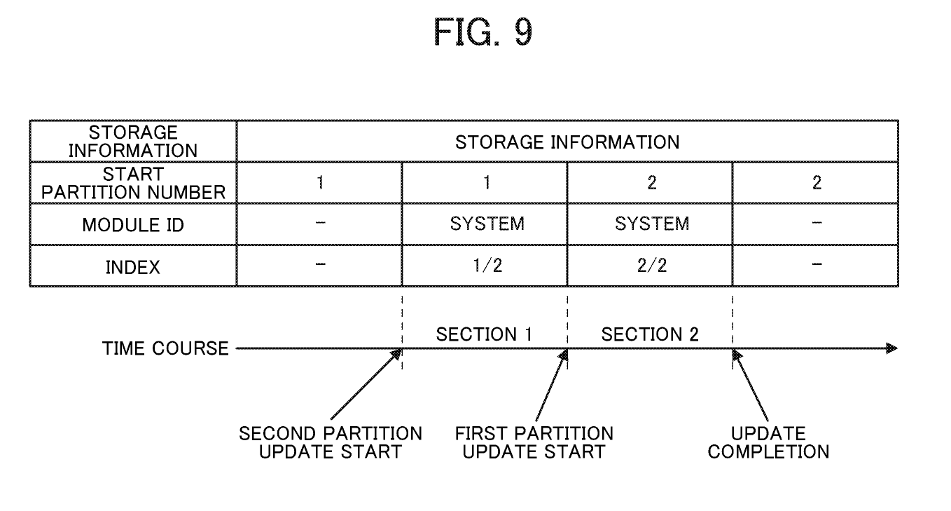

The system update processing is as described above. State transition of the storage information stored in the NVRAM 24 is summarized in FIG. 9. The storage information includes the start partition number 94 and the update interruption information 97, and the update interruption information 97 includes the module ID 115 and the index.

In a case where the partition number of the first partition 91 is set to “1” and the partition number of the second partition 92 is set to “2”, and the first partition 91 is started, “1” is set as the partition number of the partition to be started after the start. At this time, since the update interruption information 97 has not yet been set, the module ID 115 and the index are marked with a symbol “-” indicating that there is no information.

In this example, since the start partition is the first partition 91, the system to be updated is the system of the second partition 92. Therefore, when a notification of system update comes, “SYSTEM” is acquired from the module ID 115 of the common header 111 of the update file 105, for example, and “1/2” is acquired from the index specification value 118a of the primary system header 112, for example. Then, these pieces of information are set as the update interruption information 97. At this time, since the start partition number has not been updated, “1” same as before the update notification is set.

When the start partition number is updated and the system is rebooted, and the start partition becomes the second partition 92, the system to be updated becomes the system of the first partition 91. “SYSTEM” similar to the above is acquired from the module ID 115 of the common header 111 of the update file 105, and “2/2” is acquired from the index specification value 118b of the secondary system header 113, for example. Then, these pieces of information are set as the update interruption information 97. At this time, since the start partition number has been updated, “2” is set.

When the systems of both the partitions are updated, the update interruption information 97 is erased. Therefore, the module ID 115 and the index are marked with the symbol “-” indicating that there is no information. The start partition number has not been rebooted since the last update, the same “2” as before the last update is set.

Although FIG. 9 illustrates an example of starting the first partition 91 first, the second partition 92 may be started first. In this case, the start partition numbers alone are switched, which are “2” before the update notification, “2” after the update notification, “1” after the reboot, and “1” after the update completion.

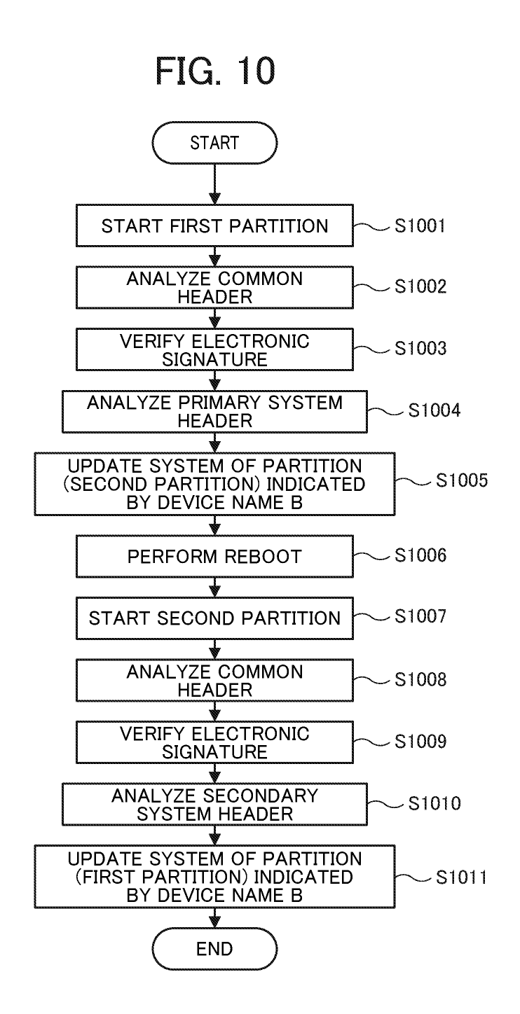

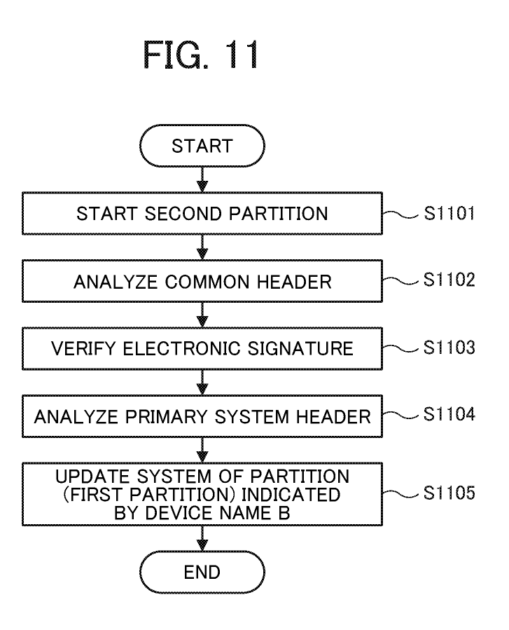

FIG. 9 has illustrated the state transition of the storage information for each section. A case where update interruption occurs in each section will be described with reference to FIGS. 10 and 11. FIG. 10 is a flowchart illustrating a flow of processing when update interruption occurs in a section 1 (a section after the update notification and before the reboot) illustrated in FIG. 9.

When the update interruption occurs in the section 1, in step 1001, the first partition 91 set with the start partition number “1” is started, and in step 1002, the common header 111 is analyzed. In step 1003, the validity of the electronic signature 122 is verified, and in step 1004, the primary system header 112 is analyzed.

In step 1005, the system of the partition indicated by the device name B, that is, the system of the second partition 92 in this example is updated. In step 1006, the system is rebooted.

In step 1007, the second partition 92 is started, in step 1008, the common header 111 is analyzed, and in step 1009, the validity of the electronic signature 122 is verified. In step 1010, the secondary system header 113 is analyzed, and the partition indicated by the device name B, here, the partition is updated to become the first partition 91, so in step 1011, the system of the first partition 91 is updated. As a result, the systems of both the partitions have been updated, and thus the processing is terminated.

FIG. 11 is a flowchart illustrating a flow of processing when update interruption occurs in a section 2 (a section after the reboot and before the update completion) illustrated in FIG. 9. In this processing, since the update of the primary system has already succeeded, the secondary system alone is updated.

When the update interruption occurs in the section 2 in FIG. 11, in step 1101, the second partition 92 set with the start partition number “2” is started. This is because after the update of the primary system, the start partition number is changed from “1” to “2”.

In step 1102, the common header 111 is analyzed, in step 1103, the validity of the electronic signature 122 is verified, and in step 1104, the secondary system header 113 is analyzed. Then, in step 1105, the system of the partition indicated by the device name B is updated. The partition indicated by the device name B is the first partition 91 different from the second partition 92 that is the active partition. When the update is completed, this processing is terminated.

In a technology of multiplexing firmware in an electronic apparatus, logical partitions (partitions) are fixed in which a primary system to be started at normal time and a secondary system to be started at update failure exist as the firmware. Therefore, in a case of starting from the update of the primary system and failing in the update, the electronic apparatus cannot be used by the user unless the primary system is updated by the secondary system after reboot and rebooting the electronic apparatus again. Accordingly, a period of time (downtime) in which the user cannot use the electronic apparatus might occur.

In the present embodiment, as described above, since the two partitions are not fixed to the partition to be normally started and the partition to be started at update failure, even if update of one of the systems fails, the other system can be normally started. Therefore, the downtime can be reduced. Further, the system can be used without being rebooted after the whole update, and the update of the secondary system can be executed in the background. Therefore, the downtime can be further reduced.

Since the systems can be configured on logical partitions that are obtained by logically dividing a storage device such as one SSD 25. Therefore, the systems can be implemented by one device, and the image forming apparatus 10 can be provided at low cost. Although the storage information has been described as being stored in the storage device (NVRAM 24) different from the storage device (SSD 25) on which the systems are mounted, the storage information may be stored in the same storage device as the storage device on which the systems are mounted. As a result, the number of devices is decreased, and the image forming apparatus 10 can be provided at lower cost.

The system may be separately configured on a storage device such as a separate SSD instead of being configured on the partition so that the apparatus can operate even if one of the devices breaks down and the reliability of the apparatus can be improved. Further, the stored information is stored in the NVRAM 24 different from the SSD 25, such that the device storing the storage information is not affected even if the device having the system breaks down, and the broken device alone can be replaced and recovered. Since newly creating storage information is not required, creation mistakes can be prevented and the reliability of the apparatus can be improved.

In the example described so far, even if the update interruption occurs, a system before update or after update exists in either of the partitions, and the system is startable. The system can be normally started and the failed system update can be resumed. Although not described in the examples, update data is written using a file system in the system update.

The file system provides a function to manage data, and holds management information. The management information is information as to where and what types of file is stored. Therefore, in a case where there is a request to access a file, the management information is referred to, and the actual file is accessed after a storage location is checked. Examples of the file system include a file allocation table (FAT) used in MS-DOS (registered trademark), a second extended filesystem (ext2), ext3, and ext4 used in Linux (registered trademark), and a unix file system (UFS) used in UNIX (registered trademark).

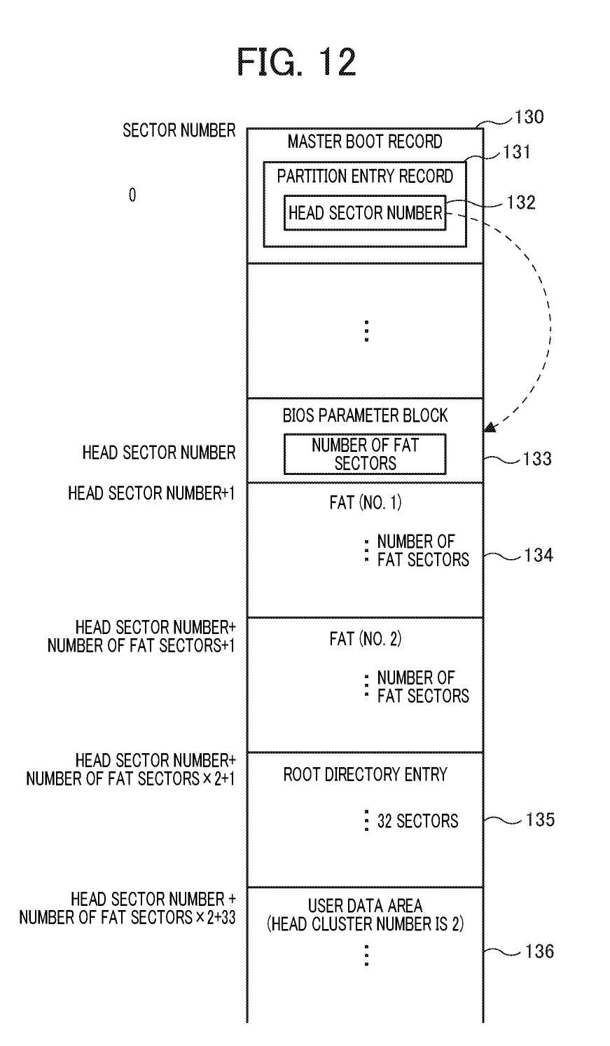

The file system will be described with reference to FIG. 12. The file system includes a master boot record (MBR) 130 for determining partition delimitation as start information to be referred to at the time of start. The MBR 130 holds a partition entry table (PET) 131, and the PET 131 stores a head sector number 132 for identifying a head sector of each partition.

Management information unique to each file system exists in the head sector of each partition. For example, a FAT file system has a structure for file management illustrated in FIG. 12.

The management information includes a basic input/output system (BIOS) parameter block (BPB) 133, a FAT 134, and a root directory entry (RDE) 135. A user data area 136 is an entity of a file and is an area in which system update content is actually written.

The BPB 133 mainly holds information of the number of bytes per sector, a minimum unit of a file size, the number of sectors per FAT, and a type. A sector is a smallest recording unit. In the FAT file system, one or more sectors are collectively managed as a cluster. There are three types of FATs 134 depending on the number of management bits of a cluster number of a cluster to be managed, and there are a FAT 12, a FAT 16, and a FAT 32 as types.

The FAT 134 is a table that manages locations of an area used by the user, a free area, an unusable area, and the like, of the user data area 136.

The FAT file system has a hierarchical file structure, and directories and folders in the highest layer of the hierarchy are called roots. The RDE 135 holds information such as name and attribute of a file placed in the root, and update date and time, and information for associating data of a file arranged at a location determined by the FAT 134.

In a case where a file is written by the system update and the user data area 136 is changed, the management information such as the FAT 134 and the RDE 135 for managing the file need to be rewritten.

In the system update, rewriting of the management information of the file system frequently occurs. Therefore, in a case where power off occurs at the time of rewriting the management information, the file cannot be normally accessed, and the management information may be unable to be recovered in some cases.

In view of the foregoing, the management information is duplicated (copied) in a partition in which a startable system exists, before rewriting of the management information, and in a case where the rewriting of the management information is interrupted due to the power off or the like and the management information becomes unrecoverable, the copied management information is written to return the system in the state before update. After the writing, the normal management information before the update exists. Therefore, the system update can be performed again.

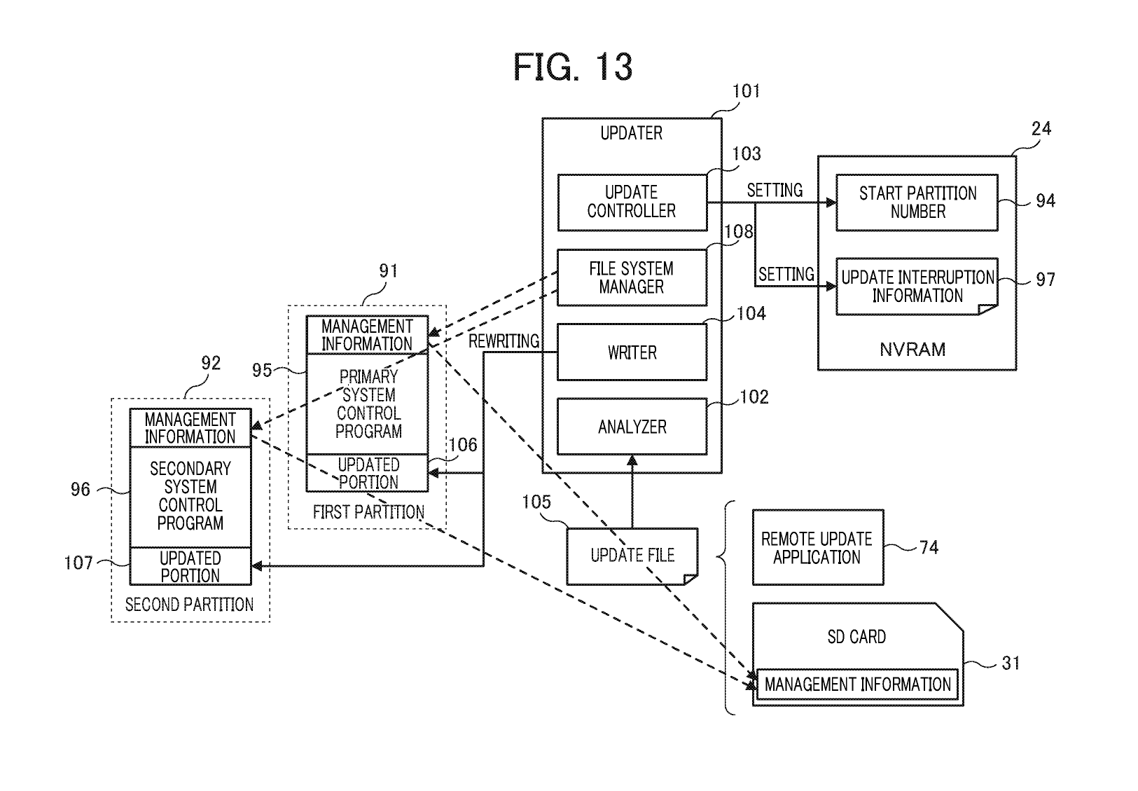

To implement the above operation, the updater 101 illustrated in FIG. 3 includes a file system manager 108, as illustrated in FIG. 13, in addition to the analyzer 102, the update controller 103, and the writer 104.

The file system manager 108 acquires the management information of the file system before update from the partition where the system to be updated exists, and copies and stores the management information in the partition where the active system exists. The file system manager 108 copies another piece of the acquired management information, and can store the management information in the SD card 31.

The file system manager 108 confirms whether mount of the partition where the system to be updated exists has succeeded. In a case where the mount fails, existence of some abnormality in the management information can be determined. Therefore, in a case where mount fails, the file system manager 108 writes the management information stored in the partition where the active system exists into the partition where the system to be updated exists to return the system to the state before update. After writing and rebooting, the management information becomes normal, mount succeeds, and the system update can be normally performed.

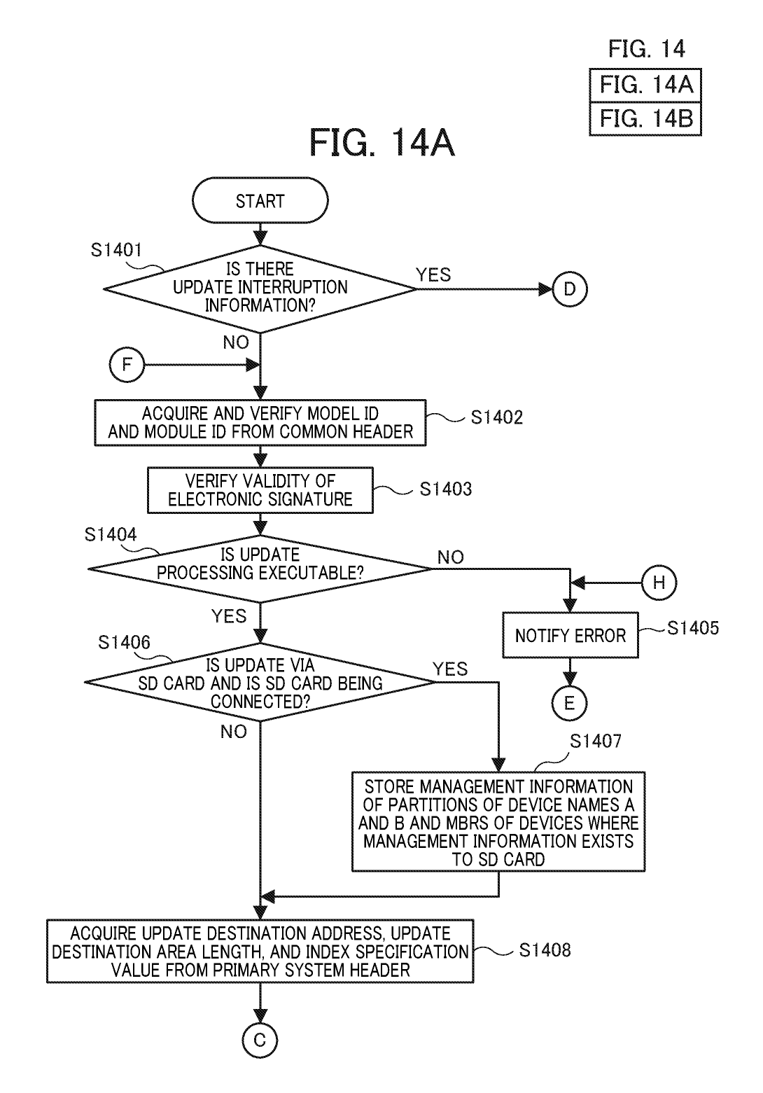

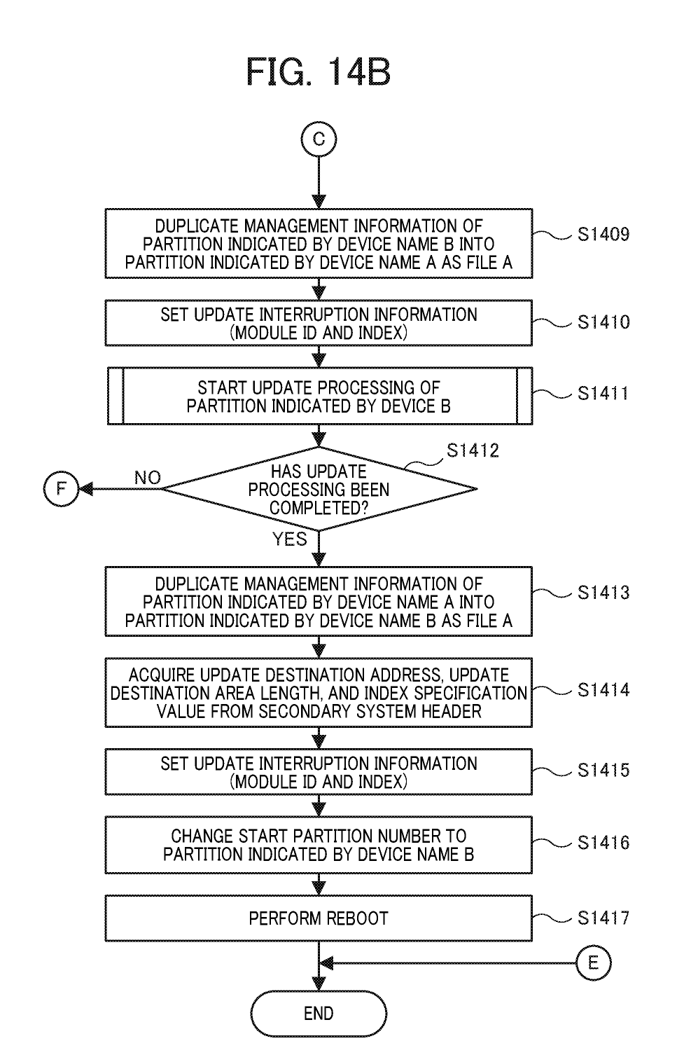

In the case of the functional configuration illustrated in FIG. 13, the process of copying the management information, determining the mount, and writing the information and rebooting when the mount fails is added to the processing executed by the image forming apparatus 10 illustrated in FIGS. 7, 8, 10, and 11. Flowcharts to which the process is added are illustrated in FIGS. 14 to 17, and each processing executed by the image forming apparatus 10 will be described with reference to FIGS. 14 to 17.

FIG. 14 is a flowchart illustrating a flow of processing in a case where a system update notification comes after completion of the start processing. Since the processing of steps 1401 to 1405, step 1408, step 1410, step 1411, and steps 1414 to 1417 is the same as the processing of steps 701 to 708 and steps 710 to 713 illustrated in FIG. 7, description of the processing is omitted.

In step 1406, in a case where update can be started, whether the update is performed via the SD card 31 and the SD card 31 is connected is confirmed. In a case where the update is performed via the SD card 31 and the SD card 31 is connected, the processing proceeds to step 1407, the management information of the file system existing in the respective partitions indicated by the device names A and B is acquired and stored in the SD card 31. At this time, the MBR 130 is also acquired and stored in the SD card 31. In a case where the update is not performed via the SD card 31 in step 1406 or where the SD card 31 is not connected, the processing directly proceeds to step 1408.

In step 1409, prior to the update of the primary system, the file system manager 108 copies the management information of the file system existing in the partition indicated by the device name B, and stores the management information into the partition indicated by the device name A as a file A. The storage of the file A is performed before the update of the system of the partition indicated by the device name B.

In step 1412, the update controller 103 confirms whether rewriting of all of modules to be updated has been completed. In a case where rewriting of any one of the modules has not been completed, the processing returns to step 1402 and rewriting of the module is performed.

When rewriting of all the modules has been completed in step 1412, the primary system has been normally updated, and thus the processing proceeds to step 1413. In step 1413, prior to the update of the secondary system, the file system manager 108 copies the management information of the file system existing in the partition indicated by the device name A, and stores the management information into the partition indicated by the device name B as the file A.

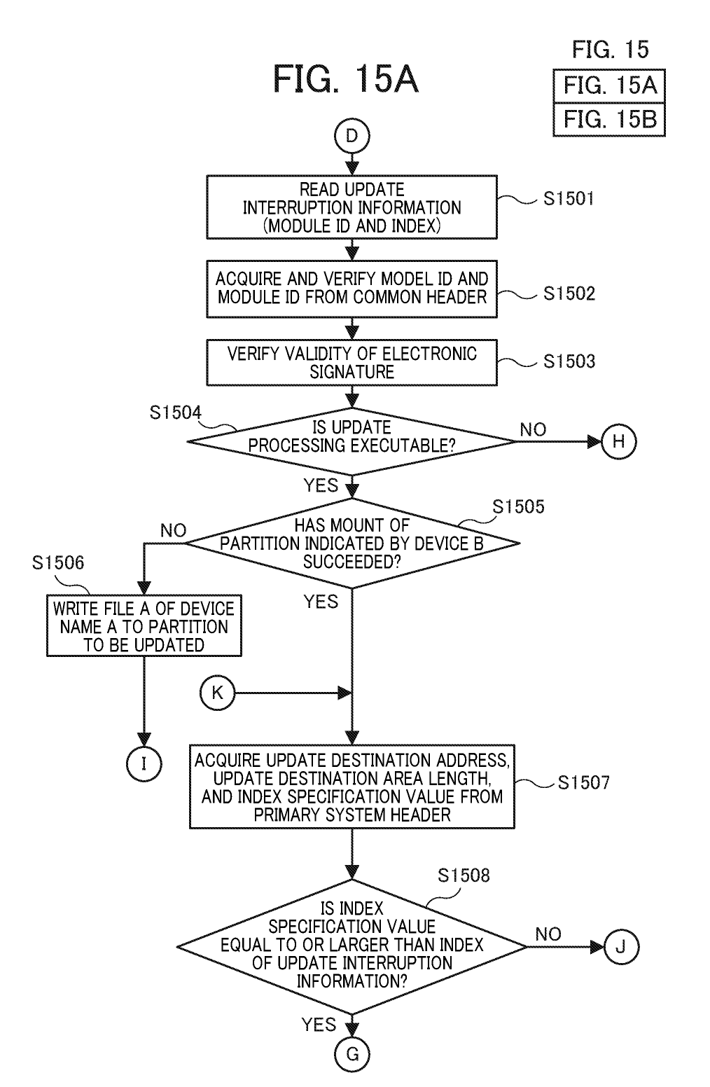

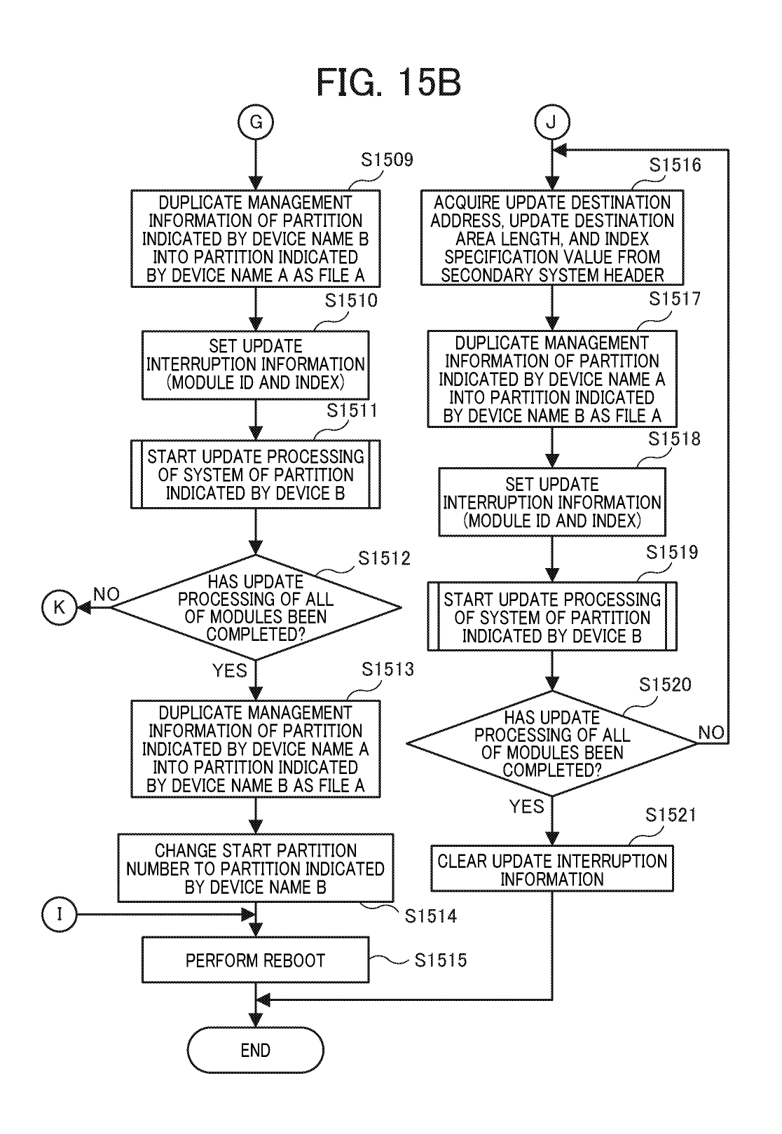

FIG. 15 is a flowchart illustrating a flow of processing in a case where the update interruption information 97 is stored in the NVRAM 24 in step 1401 of FIG. 14. Since the processing of steps 1501 to 1504, step 1507, step 1508, step 1510, step 1511, steps 1514 to 1516, step 1518, step 1519, and step 1521 is the same as the processing of steps 801 to 808, steps 810 to 814, and step 816 illustrated in FIG. 8, description of the processing is omitted.

In step 1505, the file system manager 108 confirms whether the mount of the system of the partition indicated by the device name B has succeeded. In a case where the mount fails, the processing proceeds to step 1506, and the file system manager 108 writes binary data of the file A in the partition indicated by the device name A into an area where the management information of the file system is stored in the partition to be updated. As a result, the management information can be recovered to the state before the update starts. After the writing, the processing proceeds to step 1515.

In step 1509, the file system manager 108 copies the management information of the file system existing in the partition indicated by the device name B, and stores the management information into the partition indicated by the device name A as the file A. By this processing, the management information can be recovered even if some abnormality occurs in the management information of the system to be updated.

In step 1512, the update controller 103 confirms whether rewriting of all of modules has been completed. In a case where rewriting of any one of the modules has not been completed, the processing returns to step 1507. In a case where rewriting of all the modules has been completed, the processing proceeds to step 1513, and the file system manager 108 copies the management information of the file system existing in the partition indicated by the device name A, and stores the management information into the partition indicated by the device name B as the file A. By this processing, the management information can be recovered even if some abnormality occurs in the management information of the system currently active and to be updated next.

In step 1517, the file system manager 108 copies the management information of the file system existing in the partition indicated by the device name A, and stores the management information into the partition indicated by the device name B as the file A. By this processing, the management information can be recovered even if some abnormality occurs in the management information of the system to be updated.

In step 1520, similarly to step 1512, the update controller 103 confirms whether rewriting of all the modules has been completed. In a case where rewriting of any one of the modules has not been completed, the processing returns to step 1516.

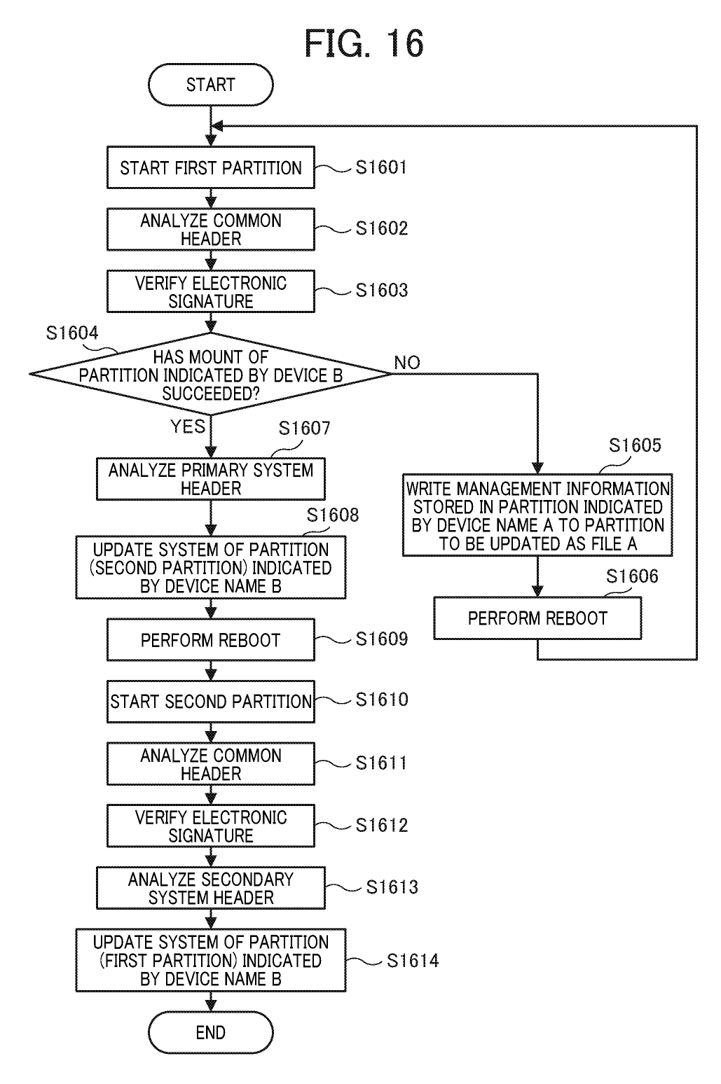

FIG. 16 is a flowchart illustrating a flow of processing when update interruption occurs in the section 1 illustrated in FIG. 9. Since the processing of steps 1601 to 1603 and steps 1607 to 1614 is the same as the processing of steps 1001 to 1011 illustrated in FIG. 10, description of the processing is omitted.

After verifying the validity of the electronic signature 122, in step 1604, the file system manager 108 confirms whether the mount of the partition indicated by the device name B has succeeded. In the case where the mount has succeeded, the processing proceeds to step 1607, and the primary system header 112 is analyzed.

In the case where the mount has failed, the processing proceeds to step 1605, and the management information stored as the file A in the partition indicated by the device name A is written into the partition where the system to be updated exists. Then, the system is rebooted in step 1606, and the processing returns to step 1601. As a result, the management information can be returned to the state before the update, and the system update can be performed again.

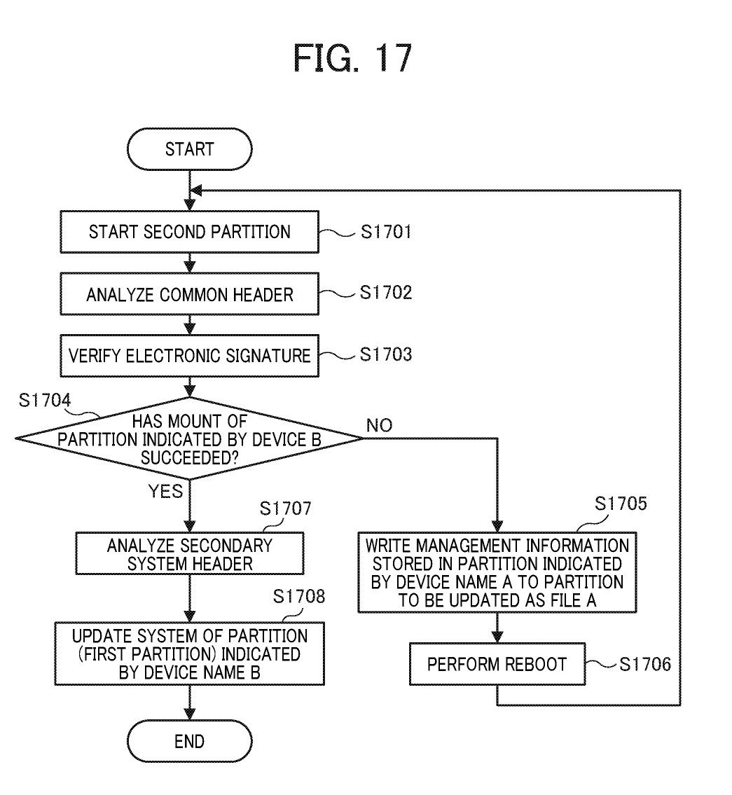

FIG. 17 is a flowchart illustrating a flow of processing when update interruption occurs in the section 2 illustrated in FIG. 9. Since the processing of steps 1701 to 1703 and steps 1707 to 1708 is the same as the processing of steps 1101 to 1105 illustrated in FIG. 11, description of the processing is omitted.

After verifying the validity of the electronic signature 122, in step 1704, the file system manager 108 confirms whether the mount of the partition indicated by the device name B has succeeded. In the case where the mount has succeeded, the processing proceeds to step 1707, and the secondary system header 113 is analyzed.

In the case where the mount has failed, the processing proceeds to step 1705, and the management information stored as the file A in the partition indicated by the device name A is written into the partition where the system to be updated exists. Then, the system is rebooted in step 1706, and the processing returns to step 1701. As a result, the management information can be returned to the state before the update, and the system update can be performed again.

As described above, the management information is copied and left before the update of the system, whereby the management information can be recovered and returned to the state before the update even when the update fails due to power off during the system update, the management information is destroyed, and the original file configuration becomes in an unrecoverable state.

Further, the MBR 130 is also stored in the SD card 31, in addition to the management information, whereby the boot loader 90 can correctly start the system, using the information of the MBR 130 stored in the SD card 31, even when the MBR 130 is destroyed and the system cannot be started, and fault tolerance of the image forming apparatus 10 can be improved.

In the above description, the management information of the file system in the partition where the system to be updated exists is copied and stored in the partition where the active system exists, and in a case where the management information is destroyed, the management information is written and recovered. However, the present embodiment is not limited to the case, and the management information of the file system in the partition where the active system exists is copied and written into the partition where the system to be updated exists, and the management information may be recovered. As a result, power off in the processing of copying and storing the management information does not need to be considered and the fault tolerance can be improved.

The present disclosure has been described with examples of an electronic apparatus and a program in the above embodiments. However, the present invention is not limited to the above-described embodiments, and can be changed within the range conceivable by a person skilled in the part, such as other embodiments, additions, modifications, and deletions. Further, any of embodiments is included in the scope of the present invention as long as the embodiment exhibits the functions and effects of the present invention. Therefore, a recording medium on which the program is recorded, a program providing server for providing the program, and the like can also be provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An electronic apparatus comprising:
one or a plurality of devices to store a plurality of multiplexed systems; and
processing circuitry to
refer to specification information specifying a system to be started,
set, as a system to be updated, a second system different from a first system specified as the system to be started, the plurality of multiplexed systems including the first system and the second system,
read a control program corresponding to the first system specified as the system to be started, to execute start processing on the first system,
set update progress information indicating a progress state of update processing according to system update information acquired from an outside of the electronic apparatus, and
change the system to be started, which is specified in the specification information, from the first system to the second system after completion of update processing of a control program corresponding to the second system set as the system to be updated.

2. The electronic apparatus according to claim 1,
wherein the plurality of multiplexed systems exists in a plurality of logical partitions, respectively, into which a storage area of the one device is logically divided or in a plurality of storage areas, respectively, of the plurality of devices, and
wherein the processing circuitry allocates a logical partition or a storage area in which the second system exists, to device information to be referred to as a device in which the system to be updated exists, to set the second system as the system to be updated.

3. The electronic apparatus according to claim 2,
wherein the processing circuitry duplicates management information for managing the logical partition or the storage area in which the second system exists, into a logical partition or a storage area in which the first system exists, before executing the update processing of the control program corresponding to the second system.

4. The electronic apparatus according to claim 3,
wherein, in a case where the logical partition or the storage area in which the second system exists cannot be allocated to the device information, the processing circuitry writes the management information duplicated into the logical partition or the storage area in which the first system exists, into the logical partition or the storage area in which the second system exists.

5. The electronic apparatus according to claim 3,
wherein the processing circuitry acquires the system update information from an external recording medium and duplicates, into the external recording medium, the management information including start information to be used in the start processing.

6. The electronic apparatus according to claim 2,
wherein, in a case where the logical partition or the storage area in which the second system exists cannot be allocated to the device information, the processing circuitry writes management information for managing the logical partition or the storage area in which the first system exists, into the logical partition or the storage area in which the second system exists.

7. The electronic apparatus according to claim 1, further comprising a memory to store the specification information.

8. The electronic apparatus according to claim 1,
wherein the processing circuitry executes the update processing in a background according to the update progress information.

9. A method for updating a plurality of systems, the method comprising:
referring to specification information specifying a system to be started;
setting, as a system to be updated, a second system different from a first system specified as the system to be started;
reading a control program corresponding to the first system to execute start processing on the first system;
setting update progress information indicating a progress state of update processing according to system update information acquired from an outside; and
changing the system to be started, which is specified in the specification information, from the first system to the second system according to the system update information after completing update processing of a control program corresponding to the second system set as the system to be updated.

10. A non-transitory recording medium storing a plurality of instructions which, when executed by one or more processors, cause the processors to perform:
setting, as a system to be updated, second system different from a first system by reference to specification information specifying a system to be started;
reading a control program corresponding to the first system, and executing start processing;
setting update progress information indicating a progress state of update processing according to system update information acquired from an outside; and
changing the system to be specified by the specification information to the second system according to the system update information after completing the update processing of a control program corresponding to the second system set as the system to be updated.
